(19) United States
(12) Patent Application Publication
(10) Pub. No.: US 2005/0236428 A1
(43) Pub. Date: Oct. 27, 2005

(54) Portable beverage container

(75) Inventors: Joel Quigley, Santa Rosa, CA (US); Paige Poulos, Berkeley, CA (US); John Woolley, Berkeley, CA (US)

Correspondence Address: DERGOSITS & NOAH LLP, FOUR EMBARCADERO CENTER, SUITE 1450, SAN FRANCISCO, CA, 94111, US

(73) Assignee: PAIGE POULOS COMMUNICATIONS

(21) Appl. No.: 11/115,902

(22) Filed: Apr. 26, 2005

Related U.S. Application Data
(60) Provisional application No. 60/565,368, filed on Apr. 26, 2004.

(51) Int. Cl. B65D 88/54; G01F 11/42; B65D 35/08; B29D 22/00

(52) U.S. Cl. 222/107; 222/323

(57) ABSTRACT

A portable beverage container is made of a flexible film and includes a resealable nozzle. The film used to construct the container includes an oxygen barrier, an insulative layer and an inner layer that is chemically compatible with the beverage. The portable beverage container is particularly suitable for storing wine because the oxygen barrier prevents oxidation of the wine. The insulative layer keeps chilled wine cool when the container is exposed to warm climates.

The present application claims priority to provisional application No. 60/565,368, filed on Apr. 26, 2004, entitled Portable Beverage Container.

### BACKGROUND

The boda or bota bag is a centuries old wine container and dispenser originally made from goat hide that is dried and then soaked in vegetable oil until it becomes pliable. The goat hide is then cut and assembled to form the boda bag's bulbous and curved design. The inside of the boda bag is cured with pine pitch to seal the vessel and a screw cap seals the tip. Today, boda bags are now made from materials other than hides, such as neoprene and include latex liners that allow for safe storage of beverages including wine. The boda bags design remains the traditional elongated shape. A cord is integrated in to the design so it can be carried over the neck or shoulder of the user.

Even with these material advances, the boda bag design has some drawbacks. The boda bag is not a freestanding beverage container. Thus, when it is placed on a table with the cap opened the beverage will leak out. The screw cap and elongated design of the boda bag, require the user to tilt the bag upright and over the head to extract the beverage. The boda bag also does not have good insulative properties. When it is placed in close proximity to the user's body, heat is easily transmitted through the material and the beverage is heated. Further, the current incarnations of the boda bag design do not allow for cost-effective, mass production of boda bags as prepackaged beverage containers.

The wine industry produces mass quantities of alcoholic beverage products for the world market. The containers used to transport and store the wines are typically either glass bottles or boxes with plastic liners. Neither of these containers are ideal. Standard 150 milliliter, 750 milliliter, and 375 milliliter wine bottles with cork closures require both tools and skill to properly remove the cork closure. This problem has been partially alleviated by screw top closures, however the glass bottle is also inherently problematic. The glass wine bottles are heavy and therefore more difficult to transport. Glass is also very brittle and is easily broken into many sharp pieces that can cause injury to people. Because of these hazards, glass bottles are frequently banned at major public events and venues.

Wine boxes are very light weight in construction but also not ideal. These boxes are typically larger in volume than wine bottles. For example, a box of wine typically contains about three liters of wine. Because of their large size and weight, these containers are limited in portability. Another problem with wine boxes is that wine stored in boxes have a very short shelf life. This is primarily due to the plastic liners that are gas permeable and expose the wine to ambient oxygen. The oxygen passes through the plastic liner packing and reacts with the wine by degrading the flavor and taste. Thus, existing plastic, laminated cardboard or film wine containers have a short shelf life.

What is needed is an improved beverage container that is an improvement over existing wine bottle and wine box technologies.

### SUMMARY OF THE INVENTION

The inventive beverage container is a flexible structure that has a bottom that allows the container to stand upright and can be made to resemble a boda bag. The upright stability allows the product to be easily displayed in stores and placed on planar surfaces after opening without spilling the contents. The inventive container is made of a film that is made of multiple layers that may be laminated together. By combining different materials, the inventive container has many advantages over the wine bottle, wine box and boda bag prior art.

In an embodiment, inventive container overcomes the prior art gas permeability problem by using an oxygen barrier. This film layer has a very low oxygen permeability to minimize the beverage's exposure to oxygen. The film used in the container has multiple layers and one or more layers have oxygen barrier properties. The oxygen barrier layer can be a polymeric layer such as polyvinyl alcohol, ethylene vinyl alcohol, polyacrylonitrile, or combinations thereof. Alternatively, the oxygen barrier can be a metal foil such as aluminum, nickel, copper, tin, stainless steel or other suitable metals. The film may include multiple oxygen barrier layers. For example, the polymeric materials can be laminated to either side of the metal layer to form a container having three oxygen barrier layers.

Although it is desirable to minimize the oxygen permeability of the packaging, in some applications it may be desirable to control the amount of oxygen that permeates the packaging depending upon the ambient conditions for storing the containers. With respect to wines, the oxygen exposure through the film can simulate the oxygen transmitted through the cork of a wine bottle. By mixing different materials in the multi-layered film described above and altering the thickness of each layer within the film laminate, the oxygen permeability of the film and the beverage's oxygen exposure can be controlled.

In another embodiment, the inventive package is made of a film having an insulative layer. In this embodiment, the film includes a layer of plastic foam such as polystyrene and polyurethane that is flexible and has good insulative properties. In an embodiment, a layer of foam is integrated into the film used to form the beverage container. Alternatively, the insulative layer may be a mesh or filler that maintains a minimum space between the inner and outer layers of the film. This space functions as the insulative layer. The insulated layer allows the beverages to be removed from a refrigerator and maintained longer at a cool temperature when the beverage is exposed to warm climates. Another advantage is that there is less need for additional devices such as coolers and ice to keep the beverages cold. The film may also have a reflective outer surface that absorbs very little light waves to prevent solar heating of the beverage. The insulative and reflective layers are particularly useful during outdoor activities where the container is exposed to sun light.

In yet another embodiment, the film may include any combination of the oxygen barrier, insulative and reflective layers. For example, the inner layer may be oxygen barrier layers that are laminated to an insulative foam core layer and an outer reflective oxygen barrier layer. This oxygen barrier and insulative film is particularly suitable for storing wine beverages. The oxygen barrier prevents oxidation of the wine during storage and the insulative layer keep the beverage cold after it is removed from the refrigerator. The soft packaging is also much safer than conventional glass bottles because the container cannot shatter into sharp pieces that can cause injury.

In an embodiment, the containers may be made in a small volume that is suitable for tasting or sample purposes. These containers may provide enough of the beverage for a single serving or even a sample tasting. These small containers may have a tip that can be torn open by the consumer to remove the beverage. For larger volume containers the inventive beverage container may include a resealable “fitment” that is attached to the top of the container. Fitments are plastic pieces that are inserted into an opening in the top of the container and fused to the film body of the beverage container. The fitment has a resealable closure that allows the user to open and consume a portion of the beverage in the container and then reseal the container to preserve and/or transport the remaining beverage. There are various types of fitment. For example, the fitment may be cap, a nozzle, a spout, a tapered tip, a push-pull cap, a flexible pull-out sipping straw or any other mechanism that allows the container to be resealed. It is also possible to install multiple fitments into the beverage container. For example, in an embodiment, one low flow nozzle fitment may be installed at one upper corner of the container and a second high flow cap fitment may be installed at a second upper corner of the container.

In addition to a resealable closure, the fitment may also include a pressure valve which prevents the liquids in the container from being accidentally spilled. The valve includes a flexible diaphragm and an orifice. The valve relief pressure can be controlled so that the container does not allow the beverage to flow through the valve until a specific pressure is applied to the container.

In alternative embodiments, the inventive beverage container may include various other accessory components. The container may have a carry shoulder strap that allows container to be easily carried or secured to the user. The container may have a pocket that can store information such as brochures, cards, computer readable media such as disks or flash memory. This information may be useful in marketing the beverage at sales meeting or major public events and venues. The containers may also have flange with a hole so that the container can be hung on a rod. The fitment may also have a groove at least partially around the outer diameter that allows the container to be held between two rods. With this configuration, the container can be sold from refrigerators in retail stores that have small display rods rather than large display shelves.

In order to optimize the packaging of mass quantities of beverages, automated machines are used to assemble and fill the inventive beverage containers. The layers of the films are laminated together and the outer layer may be printed with the desired graphics on a long continuous sheets that are stored on rolls. As discussed above, the film may include oxygen resistant and insulative layers. During the assembly of the inventive beverage containers, the film is unrolled and fed to automated machines that fabricate the beverage containers. The machines fold the film to form the bottom and sides of each container. The sides or edges of the container are sealed together by fusing the film layers together with heat or an adhesive. The partially finished containers are cut from the roll of film with an open top ready to be filled. A predetermined volume of a beverage such as wine is placed in the container. The top of the container may then be filled with nitrogen gas to remove any oxygen from the beverage before the fitment is sealed to the top of the container. The filled and sealed container is then ready for distribution and storage. Because the container has the oxygen barrier, the shelf life of wines stored in the inventive container is extended substantially.

### BRIEF DESCRIPTION OF THE DRAWINGS

FIG. 1 is a side view of an embodiment of the inventive container;

FIG. 2 is a view of the cross section of the folded construction of the container;

FIG. 3 is an illustration of the valve in the closed position;

FIG. 4 is an illustration of the valve in the opened position; and

FIG. 5 is a view of a tear away tip.

### DETAILED DESCRIPTION

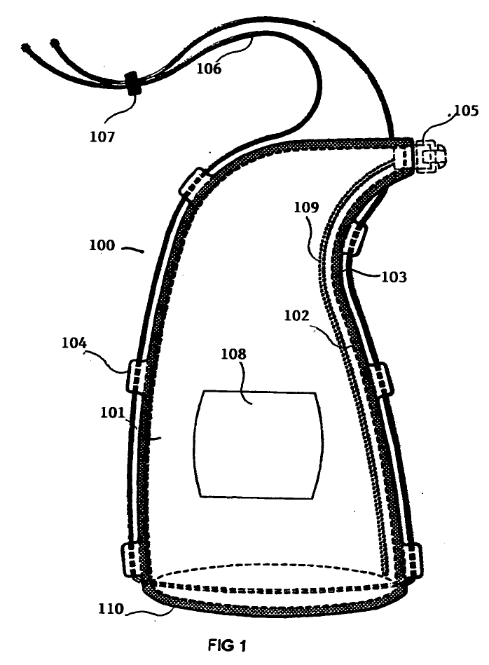

The preferred embodiment of the inventive beverage container is described with reference to FIG. 1. The container 100 has a main body 101 that is roughly cylindrical cross section and a flat base 110 which allows the beverage container 100 to stand upright on a flat surface. The top of the body 101 is tapered and may be angled to one side. A re-sealable cap fitment 105 is attached to the top of the body 101. The laminated film 103 is flexible and may include an oxygen barrier material that prevents the transmission of oxygen to keeps the beverage fresh for longer periods of time than prior art containers. The film 103 may also include an inner layer 102 that is chemically compatible (inert) with the beverage and an insulative layer that minimizes convection heat transfer and keeps the beverage cool when exposed to warm climates.

The top of the container 100 may be bent to one side so that the cap 105 may be angled to almost horizontal to improve the functionality of the beverage container 100. In this configuration, the beverage is easily poured into cups or directly into the mouths of the consumer with the container 100 in an upright position. Because the walls of the inventive container are flexible, the container 100 can be squeezed like a traditional boda bag to force the beverage out through the cap 105.

In an embodiment, a tube 109 runs to the bottom of the container 100 and is connected to the cap 105 so that the beverage can be extracted while the container 100 is in the upright position. In this embodiment, the consumer can either suck the beverage out of the container through the cap 105 or squeeze the container to drive the beverage out through the tube 109. In an embodiment, the walls 103 may be made of a resilient material that will resume its original shape. When the container is released the container 100 may expand to its original shape with the beverage at the bottom of the container 100 with ambient air now occupying the displaced beverage at the top of the container 100. By repeatedly squeezing the container 100 further, the remaining beverage in the container 100 is expelled. Alternatively, the container 100 may collapse as the beverage is extracted.

In another embodiment, the tube 109 can be pulled partially out of the container 100 through the cap 105. The cap 105 may have an integrated seal such as an o-ring or gasket that prevents the beverage from leaking from the junction between the tube 109 and cap 105. In this embodiment, the tube 109 is used like a straw and allows the consumer to sip the beverage or alternatively, the tube 109 can be used to direct the flow of the beverage from the container 100.

The cap 105 may also be removable so that the container 100 can be cleaned and refilled with another beverage by the consumer after the original beverage is consumed. The cap 105 may have a threaded connection to the container 100 that provides a leak proof seal when the cap 105 is tightened. The cap 105 may be attached to a tether so that it cannot be separated from the container 100. In this embodiment, the hole covered by the cap 105 may be large enough to permit the consumer to easily clean, rinse and refill the container 100.

The container 100 may include other features such as a loops 104 that hold a cord 106 to the container body 101. The loops 104 may be positioned around the perimeter of the container 100. The ends of the cord 106 may pass through a ring closures 107 that is secured to the cord 106 and allows the loop length of the cord 106 to be adjusted. The cord 106 can be used to carry or hang the container 100 or worn around the neck or shoulder of the individual. The cord 106 can be made of a flexible elastic material or a non-elastic line such as a braided cord. Ornamentation such as tags or promotional materials such as coupons, certificates, literature, etc. can also be attached to the cord 106.

The container 100 may also include a plastic pocket 108 that can be used to hold labels or other thin item such as a CD/DVD/CD-ROM, RFID tags, flash memory device or other materials such as educational, promotional, communications, marketing, branding documents. The materials may include computer readable data that is related to the beverage such as where the wine grapes were grown, when the grapes were harvested, where the grapes were crushed and fermented, etc. The pocket 108 may be permanently attached to the container 100 or attached with an adhesive that allows the pocket 108 to be removed.

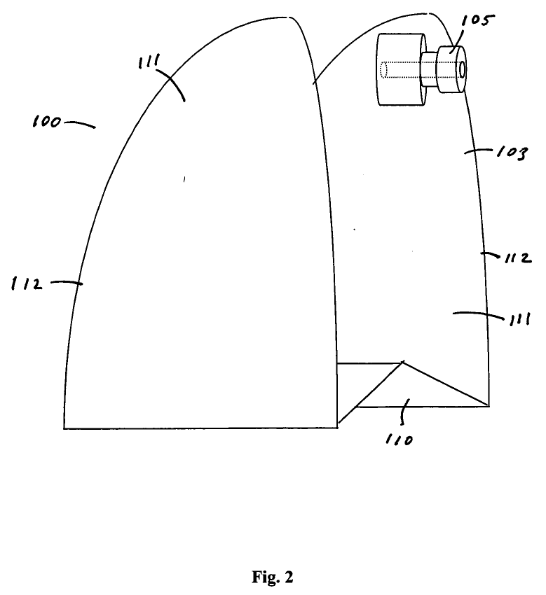

There are various ways of manufacturing the inventive beverage container. The inventive beverage container is typically formed from one or more plastic film pieces that are sealed together at the edges and form the tapered shape. With reference to FIG. 2, the container 100 can be made from a single piece of film 103 that is folded at the bottom 110. The body of the inventive beverage container may be fabricated with a folded bottom wall 110 in a “W” shape. At the bottom of the container 100, the bottom walls 110 and side walls are all fused together. At the upper portion, the two side walls 111 are fused together along the edges 112. In an embodiment, the fitment 105 is fused between the side walls 111 at the top of the container 100.

The fitment may be a separate plastic component such as a spout, a resealable nozzle, a resealable screw cap or snap cap that is attached to the container. The spout or nozzle is a separate plastic piece that is typically made through an injection molding process. The spout may be an elongated piece of tubing such as a straw that is sealed at the end. The tube may be serrated so that the user can simply break the sealed end of the tube off and open the container. The spout may also include a resealable cap, that can be placed over the spout to safely transport or store the beverage that remains in the container. The nozzle mechanism may have an orifice and a plug. In one embodiment, the orifice is part of a nozzle that can be pulled away from the plug to open the container. In another embodiment, the nozzle has threaded surfaces which control the relative positions of the orifice and plug. When the nozzle is rotated in one direction the threads separate the orifice and plug opening the container. When the nozzle is rotated in the opposite direction, the plug engages the orifice closing the container. In still other embodiments, the cap can be removable from the fitment. The cap may be attached to an elongated member to prevent the cap from being lost or separated from the container.

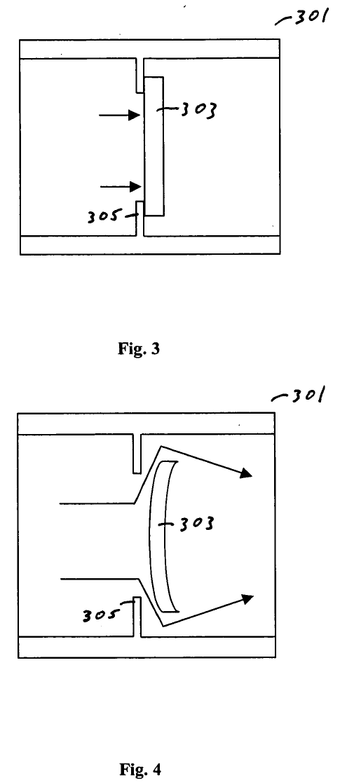

In yet another embodiment, the fitment may also include a pressure valve which prevents the beverage from being removed from the container until pressure is applied. This is particularly useful with low viscosity beverages that would normally flow out of a container through gravity alone. With reference to FIGS. 3 and 4, the pressure valve 301 may be a small diaphragm 303 that normally rests against an orifice 305. When pressure is applied to the container, the diaphragm 303 deforms and the beverage flows around the diaphragm 303 and out of the nozzle. The pressure can be applied by squeezing the container. When the pressure is released, the diaphragm 303 again seals against the orifice 305 and the beverage will not flow from the container. The pressure required to break the diaphragm 303 seal can be controlled by the stiffness of the diaphragm 303 and the size of the orifice 305. A more rigid diaphragm 303 and a small orifice 305 will require more pressure than a flexible diaphragm 303 used with a large orifice 305.

The present invention has been described as a single volume beverage container. In an alternative embodiment, the inventive container may store two or more different beverages in two or more chambers within the container. In this embodiment, the container body may be fused down the center so that there are separate left and right beverage compartments and a different fitment is inserted for each side. For example, the left chamber may store one type of wine while the right chamber may store a second type of wine. In this embodiment, the fused center of the body functions as a divider to separate the two chambers so that the beverages are not mixed. The user can then consume both wines for a variety of flavors.

The inventive beverage container may be made of a single flexible plastic film such as Mylar or polyethylene plastic. Alternatively, the film may have multiple layers of different materials that are bonded into a film. Each layer may have different physical properties so that the film can combine the desirable attributes of each layer. For example, a film may include: a high strength outer layer that is abrasion resistant, a core layer that is an oxygen barrier, an insulative layer and an inner layer that is chemically inert with the beverage.

The following is an example of a multilayer film that is compatible with wine beverages. The product packaging film has a plastic oxygen barrier core layer surrounded by two intermediate layers and two outer layers. The oxygen barrier core layer may be polyvinylalcohol (PVOH), which has low oxygen transmission characteristics. The core layer can be between about 1 microns and 50 microns thick. The intermediate layers are laminated to the core layer and include protective plastic materials whose oxygen permeability are independent of the relative humidity of the environment. Suitable intermediate layer plastic materials include polyolefin, such as polyethylene, polypropylene, polyethyleneterephthalate or polyester. The intermediate layers may be at greater than 25 microns thick. The outer layer can be an abrasive resistant silicone resin of sufficient thickness to protect the core layer. The strength of the outer layer is proportional to its thickness. Thus, the thickness must be sufficient to provide enough strength to protect the film from damage during the expected use of the container.

In alternative film layer constructions, the oxygen barrier layer can be a metal layer such as: nickel, copper, tin, stainless steel or aluminum. Various other plastic materials may be used as the oxygen barrier in the film including: polypropylene, polyester, ionomer, polyvinylchloride, polyvinyl alcohol, ethylene vinyl alcohol, polyacrylonitrile, polyethyleneterephthalate, polyester, or combinations thereof and other laminate layers.

In an embodiment, a layer of the film used in the inventive beverage container has good insulative properties. Appropriate insulative layers include low density materials that do not conduct heat well. For example, closed cell foam includes a substantial volume of trapped gases that result in good insulative properties. Because the foam may be porous, it should not be in direct contact with the beverage. The foam layer may be laminated to an inner Mylar layer that contacts the beverage. The foam may also provide a desirable texture to the outer surface of the beverage container. In other embodiments, an outer layer may be formed over the foam layer. The foam layer is not abrasion resistant and would not be a durable outer material.

Although the layers of the film are typically laminated together, it is also possible to have to non-bonded layers. For example, the inner and outer film layers of the container may only be laminated together along the edges. A low thermal conductive gas may then be injected between the inner and outer layers, such as nitrogen, helium or various other gases. This contained gas is a poor conductor of heat and therefore functions as an insulating space similar to the foam layer described above.

Another means for reducing the heat absorption is to have a reflective outer layer. When the container is exposed to light, a reflective surface will tend to reflect the incident light and solar energy rather than absorbing it. Only the absorbed light is converted into heat energy that warms the beverage in the container.

These insulative and reflective properties of the inventive beverage container are particularly important when used with wine products. It is well known that wines are damaged by variations in temperature. If the wine is exposed to excessive heat, the flavor of the wine is adversely effected. Heat increases the rate of chemical reactions and may result in odors, oxidation or a vinegary taste. The insulated and reflective inventive container reduces the risk of heat damage to the wine.

In yet another embodiment, a thermal monitoring device is attached to the container which indicates the temperature of the beverage. Normally a consumer would touch the container to determine the temperature of the beverage. However, with insulated containers it is difficult to determine the beverage temperature because the insulation functions to create a temperature differential between the interior and exterior of the container. The temperature monitor such as a liquid crystal thermometer that changes color based upon temperature can be built into the inventive beverage container. This device must be attached to the inner surface of the container and may be visible through a hole or window in the insulation and any exterior layer.

Liquid crystal thermometers indicate the current temperature with a color change to green for the rated temperature±2° F. (±1° C.). Each liquid crystal in the thermometer structure is formulated for a specific temperature response. The liquid crystal material is a twisted crystalline structure which expands and contracts as the temperature changes. Light is reflected by this structure and as it twists and untwists the color of the reflected light changes. This crystalline slurry is screened onto a black backing which permits the best viewing of the color changes. Thus, unless the temperature is within the range of the liquid crystal material, the indicating window is black.

The molecules in the liquid crystal thermometer are rod-shaped and are made of cholesteric liquid crystals. The rods form layers in the liquid crystal, the rods in adjacent layers running in a slightly different direction from those in the layer above or below. From one layer to the next, the rods form a structure like the stairs of a spiral staircase. The spiral staircase rises through a distance before the molecules twist around parallel to their original direction. When this distance equals half-a-wavelength of red light, the liquid crystal will reflect red light. When the distance is shorter, matching half a wavelength of blue light, the crystal will reflect blue light. The liquid crystals are encapsulated and packaged in microscopic plastic spheres. These liquid crystal thermometers can be cut and laminated or bonded to the inventive containers.

In an embodiment, the inventive containers are made and filled with beverage liquids by automated machines. These machines are commonly known as “automatic vertical form, fill and seal packaging machines.” The laminate films are first printed with the desired graphics and stored on rolls. The printed films are then fed to a machine that fabricates the beverage containers. The film passes through a set of plows that fold a W-shape gusset into the bottom of the container so it can stand up. The sides of the containers are sealed together by fusing the layers of film together with heat or an adhesive. The machine also cuts the film to the finished shape of the container. The sealed sides form a partially completed container with an open top. A filling tube may then be used to inject a specific volume of the beverage into the open top container. After the container is filled, top of the container may be filled with nitrogen gas to remove any oxygen and the top edge of the container is then sealed to a fitment to complete the product assembly.

As discussed, the machine seals the edges of the containers. The machine may seal the edges by heating the plastic so that it melts together or use an adhesive or glue to attach the plastic sheets together. The fusing of the films to form the containers is normally done by clamping the films for a short period of time between jaws or other pressure members. If the film has a high proportion of thermoplastic synthetic fibers, the film layers can be sealed by heat. However, if a non-thermoplastic materials are used in the film, it is necessary for the film to carry a coating of a heat or pressure activated adhesive.

The machine also includes a cutting mechanism that separates the containers from the rolls of plastic materials. The cutting mechanism can be a mechanical blade or scissors. Alternatively, the cutting mechanism can be a laser or hot knife that simultaneously cuts and seals the plastic sheets together. In addition to cutting the container away from the rolls of material, the machine may also cut away the unused side pieces of plastic to form the tapered boda bag shape.

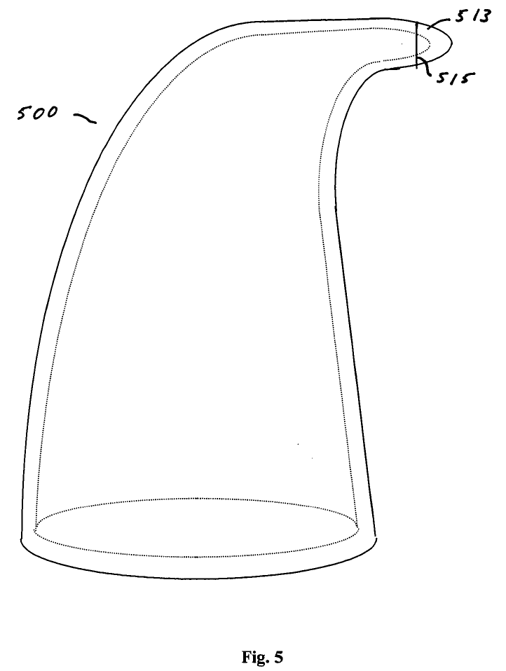

With reference to FIG. 5, for small single serving containers a fitment may not be required. The container fabrication process is the same as described above, however rather than attaching a fitment to the container 500, a tip 513 is formed. The tip 513 can include a serrated section 515 that is a structurally weakened part of the container. The serrated section 515 is easily torn away from the container 500. The outer plastic layer of the tip 513 may be scored or partially cut the with a knife, laser or any other appropriate device to form the serrated section 515. The cut or scoring must not puncture the entire thickness of the plastic layer or compromise the oxygen barrier layer. If it is necessary to reseal the container 500, the tip 513 can be resealed by folding the tip 513 and holding it in the folded position with a clamp. This embodiment may be useful for single serving or sample tasting applications.

In the foregoing, a portable beverage container has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A portable beverage container comprising:
a body made of a film that includes an oxygen barrier layer, the body having a cross section that tapers from a wider base to a narrower top;
a bottom which connected to the base of the body, wherein the base is substantially circular and allows the inventive beverage container to stand in an upright position; and
a re-sealable fitment that is attached to the top of the body and can be opened to extract the beverage from the container.

2. The portable beverage container of claim 1 wherein the film includes a thermal insulation layer that preserves the cool temperature of the beverage when the ambient temperature is warmer than the beverage temperature.

3. The portable beverage container of claim 1 wherein the film includes an inner layer that is chemically inert with wines.

4. The portable beverage container of claim 1 wherein the film includes a thermal graphics layer that is printed with information about the beverage.

5. The portable beverage container of claim 1 wherein the fitment is a screw cap that opens the container when the cap is rotated in a first direction and sealed the container with the cap is rotated in an opposite direction.

6. The portable beverage container of claim 5 further comprising a valve that prevents the beverage from flowing out of the fitment unless a predetermined pressure is applied to the container.

7. The portable beverage container of claim 1 further comprising a liquid crystal thermometer that includes a visual display that indicates the temperature of the beverage.

8. A portable beverage container comprising:
a body made of a film that includes a thermal insulative layer, the body having a cross section that tapers from a wider base to a narrower top;
a bottom which is substantially circular and connected to the base of the body, wherein the bottom allows the inventive beverage container to stand in an upright position; and
a re-sealable fitment that is attached to the top of the body and can be opened to extract the beverage from the container.

9. The portable beverage container of claim 8 wherein the film includes an inner layer that is chemically inert with wines.

10. The portable beverage container of claim 8 wherein the film includes a graphics layer that is printed with information about the beverage.

11. The portable beverage container of claim 8 wherein the fitment is a screw cap that opens the container when the cap is rotated in a first direction and sealed the container with the cap is rotated in an opposite direction.

12. The portable beverage container of claim 8 further comprising a valve that prevents the beverage from flowing out of the fitment unless a predetermined pressure is applied to the container.

13. The portable beverage container of claim 8 further comprising a computer readable data storage device that includes information about the beverage.

14. The portable beverage container of claim 8 further comprising a liquid crystal thermometer that includes a visual display that indicates if the temperature of the beverage is above or below the proper storage temperature range.

15. A portable beverage container comprising:
a body made of a film that includes an oxygen barrier layer, the body having a cross section that tapers from a wider base to a narrow top;
a bottom which is substantially circular and connected to the base of the body, wherein the bottom allows the inventive beverage container to stand in an upright position; and
a tip that is attached to the top of the body and is opened to extract the beverage from the container.

16. The portable beverage container of claim 15 wherein the film includes a thermal insulation layer that preserves the cool temperature of the beverage when the ambient temperature is warmer than the beverage temperature.

17. The portable beverage container of claim 15 wherein the film includes an inner layer that is chemically inert with wines.

18. The portable beverage container of claim 15 wherein the film includes a thermal graphics layer that is printed with information about the beverage.

19. The portable beverage container of claim 15 further comprising a liquid crystal thermometer that includes a visual display that indicates the temperature of the beverage.

20. The portable beverage container of claim 15 wherein a portion of the tip is serrated to allow the tip to be easily removed from the body.
